(19) United States
(12) Patent Application Publication
(10) Pub. No.: US 2008/0191155 A1
(43) Pub. Date: Aug. 14, 2008

(54) MAGNETICALLY COUPLED VALVE ACTUATOR

(75) Inventor: Stuart Scollay, Sunnyvale, CA (US)

Correspondence Address: NIXON PEABODY, LLP, 401 9TH STREET, NW, SUITE 900, WASHINGTON, DC, 20004-2128, US

(73) Assignee: INTEVAC, INC., Santa Clara, CA (US)

(21) Appl. No.: 11/831,695

(22) Filed: Jul. 31, 2007

Related U.S. Application Data
(60) Provisional application No. 60/889,254, filed on Feb. 9, 2007.

(51) Int. Cl. F16K 31/08

(52) U.S. Cl. 251/65; 137/1; 251/326; 414/217

(57) ABSTRACT

A valve assembly and method of actuating a valve blade in a processing chamber through the use of magnetic force coupling is disclosed. The valve assembly comprises a valve rod for imparting a reciprocal motion to a valve blade which opens and closes a valve, the valve rod having at least one magnet mounted thereupon. A housing seals the valve rod and valve blade from the ambient, and an actuator rod in the ambient, having at least one complementary magnet mounted thereupon, aligns with the magnet on the valve rod to form a magnetic coupling through the housing. An actuator mechanism then provides a reciprocal motion to the actuator rod, which transfers the motion through the magnetic coupling to the valve rod and valve blade. Multiple actuator mechanisms can also be employed to vary the force applied to the valve blade to further increase the life of the valve assembly while still providing a strong seal between processing chambers. The design allows for very high speed operation of the valve with low maintenance costs.

### RELATED APPLICATIONS

This application claims the benefit of priority to U.S. Provisional Application No. 60/889,254, filed Feb. 9, 2007, entitled “Magnetically Coupled Gate Valve Actuator,” the disclosure of which is incorporated herein in its entirety.

### BACKGROUND

1. Field of the Invention

The subject invention relates to an actuator of a valve enabling separation between two processing chambers of equal or different vacuum levels.

2. Related Art

Various fabrication equipment, such as semiconductor, flat-panel display, and hard disk drive use fabrication chambers that are pumped to an internal pressure different from the ambient, or atmosphere. Generally, these chambers operate under vacuum and require separation from one another during the fabrication process. Therefore, a valve is provided to enable loading and unloading of the work piece from one chamber to the next during the fabrication process. The valve is capable of forming a tight seal to prevent contamination from one chamber to another, and it must also form a seal tight enough to maintain the vacuum inside adjacent chambers if one chamber is exposed to the ambient, as required for service or maintenance operations. The valve is generally actuated by a mechanism operating in the ambient, requiring a seal between the actuating mechanism and the valve itself.

FIG. 1 shows an example of a prior art valve 120 that is used to separate two processing chambers 110 and 115. A specimen 100, such as a semiconductor wafer or a hard disk for a disk drive, needs to be moved from chamber 110 to chamber 115. Valve 120 separates the two chambers by valve blade 130. The valve blade 130 is movable by the rod 150, which is actuated by an actuator mechanism 155. To separate the vacuum environment from the ambient, bellows 140 are used and move with the rod 150. The bellows 140 are acted on directly by air cylinders (not pictured) to provide the opening and closing forces on the valve blade 130. However, the movement of the bellows 140 traps particles in its folds, creating additional stress and eventual leaks, diminishing performance of the valve 120 over time. Furthermore, since the valve 120 is opened and closed many times during processing, the seals in the air cylinders used to actuate the valve slowly wear out and cause unpredictable opening and closing times. Eventually, these leaks require repair of the worn components, halting the entire fabrication process while maintenance is performed. Down time for systems such as these costs significant time and money. Conventional systems may have over 20 such valves, where failure of a single bellows may require shutting down the entire system.

Additionally, the bellows system provides only one continuous force on the valve blade 130 that is sufficient to both actuate the valve blade 130 from an open position into a closed position and maintain the valve blade 130 in the closed position during processing in each adjacent chamber 110 and 115. However, the same force being used to actuate the valve blade 130 is not necessary once the valve 120 is in the closed position. Furthermore, when one of the processing chambers 110 and 115 on either side of the valve 120 requires maintenance, the valve must form a tighter seal than normal to maintain the vacuum in one chamber while the adjacent chamber is exposed to the ambient. In this situation, the valve assembly must be set to always provide enough force to close the valve in a maintenance operation, even if the valve is only operating during its normal processing procedure. Providing unneeded force on the valve blade 130 causes additional wear and tear on the valve blade 130 and the seal around the valve, meaning that the seal and valve blade 130 deteriorate faster and must be replaced or repaired as well. As with the maintenance on the bellows 140, maintenance on the valve blade 130 and seal requires shutting down the entire fabrication process, costing time and money.

Therefore, what is needed is a valve assembly that is durable, operates at high speeds, requires little maintenance, and is capable of applying different levels of force so as to prevent unnecessary wear and tear on the valve blade during normal operation.

### SUMMARY

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Various aspects of the subject invention provide an improved valve which provides isolation from the ambient and avoids the use of bellows, so as to increase the reliability of the system. A valve assembly and method of actuating a valve in a processing chamber through the use of magnetic force coupling is disclosed. The valve assembly comprises a valve rod for imparting a reciprocal motion to a valve blade which opens and closes a valve, the valve rod having at least one magnet mounted thereupon. A housing seals the valve rod and valve blade from the ambient, and an actuator rod in the ambient, having at least one complementary magnet mounted thereupon, aligns with the magnet on the valve rod to form a magnetic coupling through the housing. An actuator mechanism then provides a reciprocal motion to the actuator rod, which transfers the motion through the magnetic coupling to the valve rod and valve blade, thereby opening and closing the valve. The design allows for very high speed operation of the valve, low particle generation due to the absence of bellows, more robust vacuum isolation and lower maintenance costs.

According to embodiments of the invention, a valve assembly for a processing chamber is provided, comprising: a valve blade operable to seal an opening of the chamber; a valve rod for imparting a reciprocal motion to a valve blade so as to seal and unseal the opening of the chamber, the valve rod having at least one magnet mounted thereupon; a housing sealing the valve rod from the ambient; an actuator arm having at least one complementary magnet mounted thereupon, wherein the magnet on the valve rod and the magnet on the actuator arm form a magnetic coupling through the housing; and an actuator mechanism providing reciprocal motion to the actuator arm. The actuator arm may be a hollow cylinder provided about the housing, such that the housing fits into the hollow cylinder to form the magnetic coupling. The actuator arm may have an arrangement of magnets applied to an inner surface of the hollow cylinder of the actuator arm. The valve rod may be substantially surrounded by a plurality of magnets. The valve assembly may further comprise at least one additional valve rod for imparting reciprocal motion to the valve blade. Each of the at least one additional valve rod may be matched by one actuator arm such that there are multiple actuator arms, and wherein there is one actuator arm per valve rod. The multiple actuator arms may be coupled to a single actuator base so that the multiple actuator arms operate synchronously. More than one actuator mechanism may be connected with the actuator arm. The multiple actuator mechanisms can be selectively operated to provide additional force to the valve blade or to provide less force to the valve blade. The actuator mechanism may be a rotating lever arm movable by a motor. The actuator mechanism may be a servo motor activated by a gear head, and wherein the servo motor provides position feedback on the state of the valve. The valve rod may be supported within the housing by at least one guide.

According to further aspects of the invention, a method of actuating a valve blade in a processing chamber is provided, comprising the acts of: actuating an actuator mechanism to impart a reciprocal motion to an actuator arm, the actuator arm having at least one magnet mounted thereupon; forming a magnetic coupling between the magnet mounted to the actuator arm and a magnet mounted to a valve rod, wherein the magnets are separated by a housing that seals the valve rod and attached magnet from the ambient; imparting the reciprocal motion from the actuator arm to the valve rod through the magnetic coupling; and imparting the reciprocal motion from the valve rod to a valve blade. The method may comprise the act of providing at least two valve rods for imparting reciprocal motion to the valve blade. The method may further comprise the act of positioning one actuator arm alongside each valve rod such that there are multiple actuator arms, wherein there is one actuator arm per valve rod. The method may further comprise the act of coupling each of the multiple actuator arms to a single actuator base so that the multiple actuator arms operate synchronously. The method may further comprise the act of connecting more than one actuator mechanism with the actuator arm. The method may further comprise the act of selectively operating any number of the multiple actuator mechanisms to provide a desired force to the valve blade, wherein operating a greater number of actuator mechanisms will provide a greater force to the valve blade, and wherein operating a smaller number of actuator mechanisms will provide a lesser force to the valve blade.

According to yet further aspects of the invention, a valve assembly for a processing chamber is provided, comprising: a valve blade reciprocally housed in a valve housing; at least two valve rods, each of the valve rods reciprocally hosed in a vacuum tight housing, each of the rods having at least one magnet mounted thereupon and each of the valve rods imparting a reciprocal motion to the valve blade; at least two actuator arms, each of the actuator arms having at least one complementary magnet mounted thereupon in a complementary position to the magnet mounted on a corresponding valve rod, wherein the magnet on the valve rod and the magnet on the actuator arm form a magnetic coupling through the housing; and, a base coupling the at least two actuator arms so that the two actuator arms move in unison. The valve assembly may further comprise an actuator mechanism providing reciprocal motion to the base.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic illustration of a valve according to the prior art.

FIG. 2 is a schematic illustration of a valve according to an embodiment of the invention.

FIG. 3 depicts a system using a valve according to the embodiment FIG. 2.

FIG. 4 depicts another embodiment of the invention wherein the actuator mechanism is provided in the form of a cam and a follower.

FIG. 5 provides yet another embodiment wherein the actuator mechanism is a rotating arm movable by motor.

FIG. 6A depicts an embodiment wherein the actuator rod is a hollow cylinder provided about the housing; while FIG. 6B illustrates a similar arrangement driven by a servo motor with feedback.

FIG. 7 depicts another embodiment wherein the valve is activated by two valve rods, and where the two valve rods are powered by up to three actuator mechanisms.

FIG. 8 depicts a valve assembly according to another embodiment of the invention.

### DETAILED DESCRIPTION

FIG. 2 is a schematic illustration of a valve arrangement according to an embodiment of the invention. As shown in FIG. 2, valve 220 (shown partially) separates chambers 210 and 215 (shown partially). The valve 220 includes a valve blade (not shown) that is activated by valve rod 250. Valve rod 250 is fitted with magnets 270, and is sealed from the ambient by a housing 280. The valve rod 250 is freely movable as shown by arrow B′ and is held in place by guides 275. On the other hand, actuator mechanism 255 actuates an actuation rod 260 in a reciprocal motion as shown by arrow B. The actuation rod 260 is also fitted with a magnet 265 that is the polar opposite of the magnet on the valve rod, creating an attractive magnetic field. Consequently, when the actuator rod 260 moves, the magnetic field of magnets 265 and 270 interact to form a magnetic coupling so that valve rod 250 follows the motion of actuator rod 260, to thereby move the valve blade and close and open the valve 220.

The valve assembly has applications in many types of fabrication equipment where multiple chambers must be separated during the fabrication process. Hard disk fabrication, semiconductor fabrication and flat panel display fabrication processes all use similar systems. The valve assembly of the present invention provides a strong, durable seal between the pressurized chambers and the ambient, since the housing protecting the valve rod is fixed in position. In the valve assembly of the invention, one advantage over the prior art is the more durable separation between the internal pressure of the processing chamber

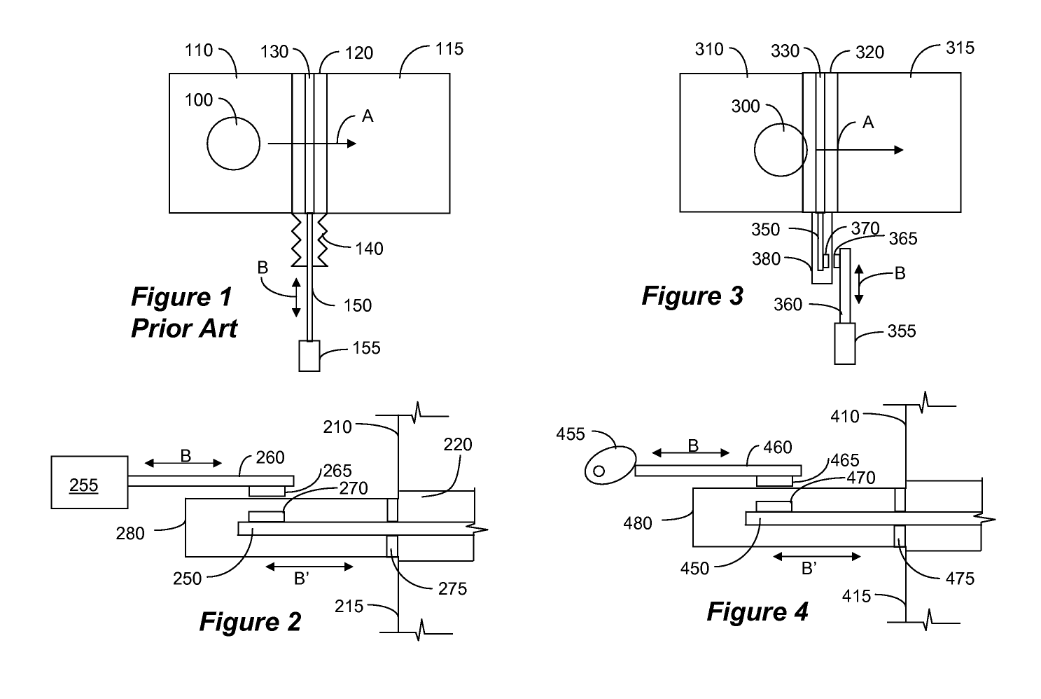

FIG. 3 is a schematic illustration of an embodiment of the invention wherein the inventive valve assembly is used to separate two processing chambers, similar to the chambers shown in FIG. 1. As shown in FIG. 3, specimen 300 is to be moved from chamber 310 to chamber 315, which are isolated from each other by valve 320. The valve 320 includes a valve blade 330, which is movable by valve rod 350. Valve rod 350 is fitted with a magnet 370. An actuator mechanism 355 actuates actuator rod 360, which is also fitted with a magnet 365. When the actuator rod 360 moves, as shown by arrow B, the magnetic fields of magnets 365 and 370 interact to form a magnetic coupling and thereby cause valve rod 350 to follow the motion of the actuator rod 360, and thereby open and close the valve 320.

As shown in FIG. 4, the valve rod 450 is sealed from the ambient by housing 480. The valve rod 450 does not directly contact the housing 480, as guides 475, such as low friction bushings or roller bearings support the valve rod 450 inside the housing. The lack of direct contact between the valve rod 450 and the housing 480 allows the assembly to move at high speeds without creating significant friction or that would otherwise lead to leaks. This prolongs the life of the entire valve assembly and requires less maintenance over time, while additionally increasing the speed of the valve and therefore the manufacturing process as a whole.

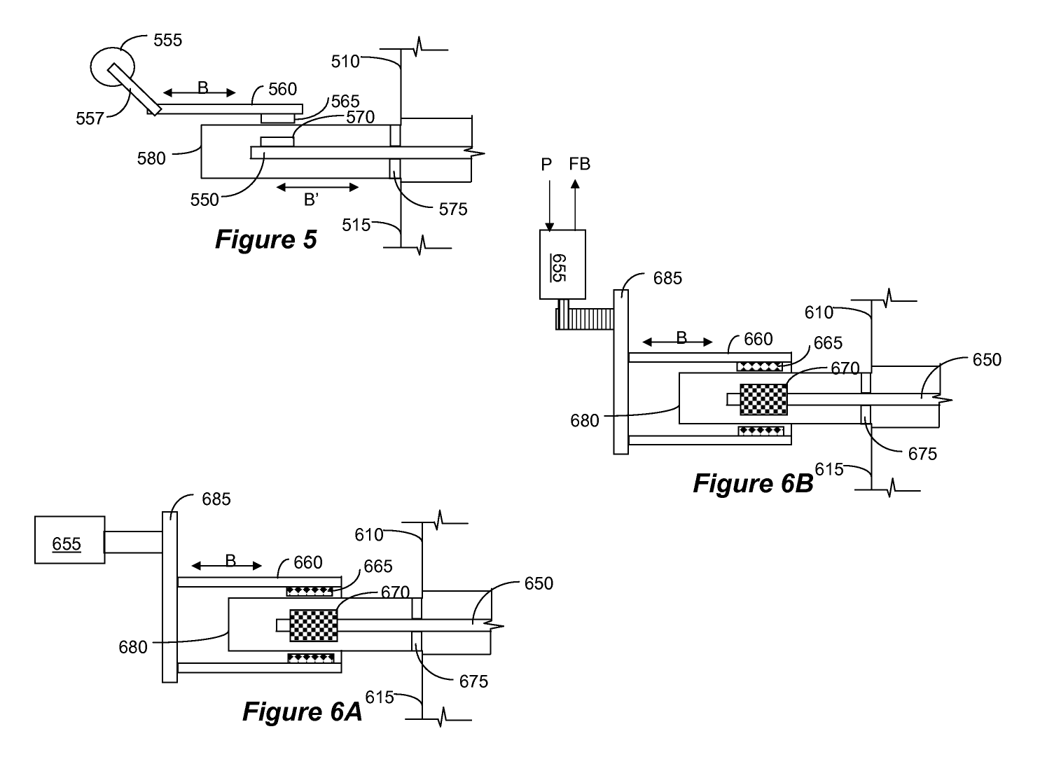

FIG. 4 depicts another embodiment of the invention wherein the actuator mechanism is provided in the form of a cam 455 and a follower 460. Otherwise, the setup is the same as that of FIG. 2. In another embodiment (not shown), the actuator mechanism is a servo motor acting through a gear head to move the actuator rod (not shown). The servo motor has high torque and high speed capabilities and provides position feedback to know the state of the valve. Other types of rotary motors can be used, such as a stepper, DC, or AC motor. FIG. 5 depicts an embodiment wherein the actuator mechanism is a rotating arm 557 movable by motor 555. Otherwise, the setup is similar to that of FIG. 2. Alternatively, an air cylinder at atmosphere could also be used to move the magnetic coupling.

The use of a rotating arm or cam provides the additional benefit of applying a “soft stop” at the position where the valve blade closes the valve gate and forms a seal between adjacent chambers. During rotation of a cam, the maximum speed achieved while the valve blade is closing, but as the valve blade reaches the closed position, the rotation of the cam lessens the force being applied to the valve blade, thereby achieving a soft stop. This preserves the life of the valve blade and the seal by only applying the minimum amount of force necessary to close the valve blade, rather than a continuous amount of force, as is found in the prior art.

FIG. 6A depicts an embodiment wherein the actuator rod 660 is a hollow cylinder provided about the housing 680. The hollow cylinder has a magnet arrangement 665 applied to the inner surface thereof. The magnet arrangement 665 may be a plurality of magnets arranged in a circular manner to oppose magnet arrangement 670 provided to the valve rod 650. The actuator rod 660 is movable by base 685, which is actuated by actuator mechanism 655. In one embodiment, linear rails (not pictured) are placed on the ambient side of the housing to support the magnetic coupling of the actuator rod 660 to the valve rod 650. As can be understood, any manner of actuating the motion of cylindrical rod 660 can be operable with this and any other embodiments described herein.

FIG. 6B illustrates a similar arrangement as that of FIG. 6A, except that the base 685 is actuated by a servo motor 655 coupled to a rack-and-pinion arrangement 657. The servo motor has a power line, indicated as P, and a feedback line, indicated as FB. The feedback line provides an indication of the rotational status of the motor, which can be associated with the closure status of the valve.

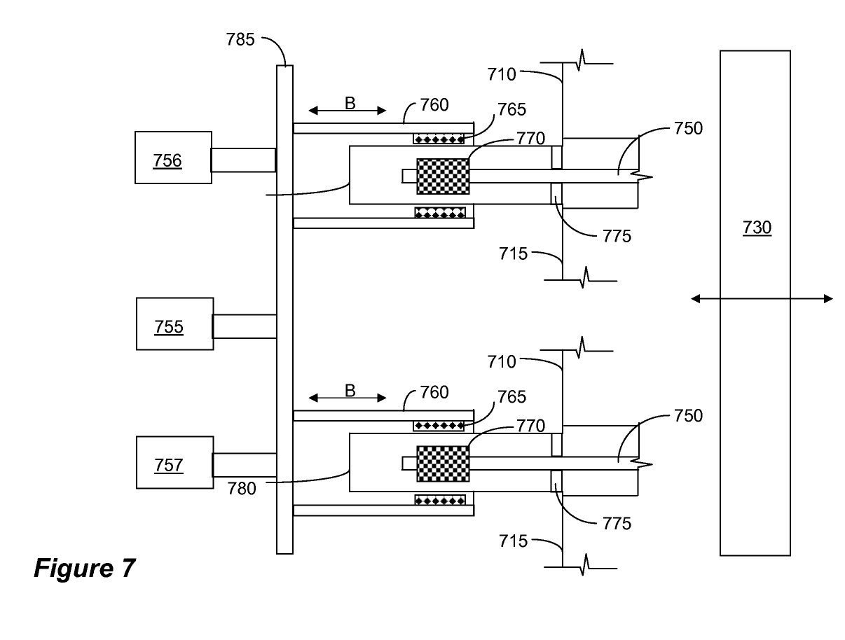

FIG. 7 depicts another embodiment wherein the valve is activated by two valve rods 750. Each of the valve rod arrangements can be provided according to any of the embodiments described above. As shown, the two valve rods 750 operate a single valve blade 730. The two valve rods 750 are operated synchronously by having the two cylindrical actuator rods 760 coupled to a single base 785. The single base 785 can be moved by a single actuator mechanism 755. In another feature of this embodiment, more than one actuator mechanism can be utilized to vary the force being applied to the valve blade 730. FIG. 7 depicts three actuator mechanisms 755, 756, and 757. According to this feature, during normal operation when the valve is cycled for specimen transfer, only one actuator mechanism, say 755, is used to move the base 785 and actuate the valve blade 730. In this manner, the closing of the valve blade 730 is performed with minimal required force. This minimized force extends the life of the valve blade 730 by not applying additional stress to the components during each cycle. When the valve needs to be sealed for maintenance operations, all three actuator mechanisms, 755, 756, and 757 are used to endure a fully sealed valve. In this manner, a stronger seal is assured by the increased force of all three actuator mechanisms, so that one side of the valve can be opened to the ambient while the other side is maintained in a vacuum.

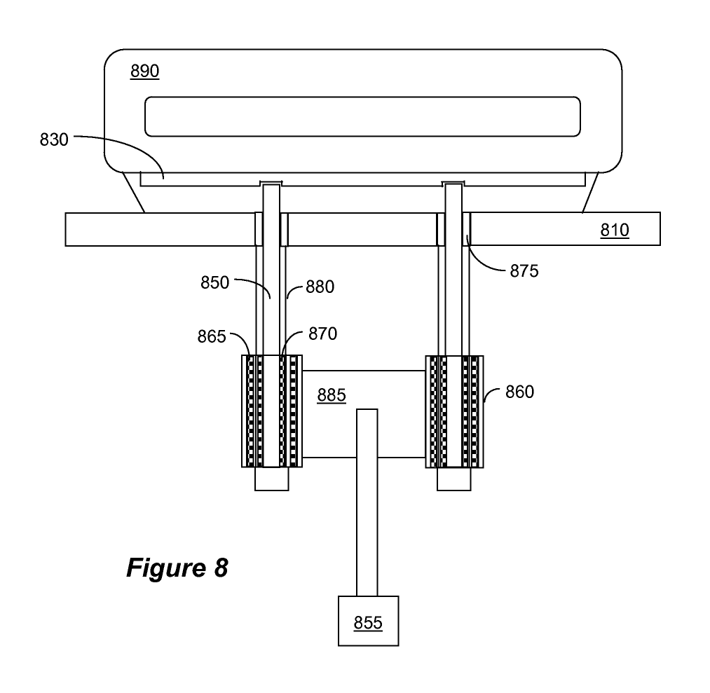

FIG. 8 depicts a valve assembly according to another embodiment of the invention. In FIG. 8, actuator 855 may be any of the actuators exemplified above, or any other suitable actuator. Here the actuator 855 is coupled to a movable base 885. The movable base has two actuator rods 860 in the form of hollow cylinders. The actuator rods 860 have magnets 865 provided on the interior periphery thereof. Complementary magnets 870 are provided on the valve rods 850, which are housed inside a vacuum tight housing 880. The housing 880 is coupled to the chamber wall section 810, and guides 875 are provided to guide the valve rods 850. The valve rods 850 are coupled to valve blade 830, which is secured inside blade housing 890.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. It is intended that the specification and examples be considered as exemplary only, with a true scope and spirit of the invention being indicated by the following claims.

What is claimed is:

1. A valve assembly for a processing chamber, comprising:
a valve blade operable to seal an opening of the chamber;
a valve rod for imparting a reciprocal motion to a valve blade so as to seal and unseal the opening of the chamber, the valve rod having at least one magnet mounted thereupon;
a housing sealing the valve rod from the ambient;
an actuator arm having at least one complementary magnet mounted thereupon, wherein the magnet on the valve rod and the magnet on the actuator arm form a magnetic coupling through the housing; and
an actuator mechanism providing reciprocal motion to the actuator arm.

2. The valve assembly of claim 1, wherein the actuator arm is a hollow cylinder provided about the housing, such that the housing fits into the hollow cylinder to form the magnetic coupling.

3. The valve assembly of claim 2, wherein the actuator arm has an arrangement of magnets applied to an inner surface of the hollow cylinder of the actuator arm.

4. The valve assembly of claim 1, wherein the valve rod is substantially surrounded by a plurality of magnets.

5. The valve assembly of claim 1, further comprising at least one additional valve rod for imparting reciprocal motion to the valve blade.

6. The valve assembly of claim 5, wherein each of the at least one additional valve rod is matched by one actuator arm such that there are multiple actuator arms, and wherein there is one actuator arm per valve rod.

7. The valve assembly of claim 6, wherein the multiple actuator arms are coupled to a single actuator base so that the multiple actuator arms operate synchronously.

8. The valve assembly of claim 1, wherein more than one actuator mechanism is connected with the actuator arm.

9. The valve assembly of claim 8, wherein the multiple actuator mechanisms can be selectively operated to provide additional force to the valve blade or to provide less force to the valve blade.

10. The valve assembly of claim 1, wherein the actuator mechanism is a rotating lever arm movable by a motor.

11. The valve assembly of claim 1, wherein the actuator mechanism is a servo motor activated by a gear head, and wherein the servo motor provides position feedback on the state of the valve.

12. The valve assembly of claim 1, wherein the valve rod is supported within the housing by at least one guide.

13. A method of actuating a valve blade in a processing chamber, comprising the acts of:
actuating an actuator mechanism to impart a reciprocal motion to an actuator arm, the actuator arm having at least one magnet mounted thereupon;
forming a magnetic coupling between the magnet mounted to the actuator arm and a magnet mounted to a valve rod, wherein the magnets are separated by a housing that seals the valve rod and attached magnet from the ambient;
imparting the reciprocal motion from the actuator arm to the valve rod through the magnetic coupling; and
imparting the reciprocal motion from the valve rod to a valve blade.

14. The method of claim 13, comprising the act of providing at least two valve rods for imparting reciprocal motion to the valve blade.

15. The method of claim 14, further comprising the act of positioning one actuator arm alongside each valve rod such that there are multiple actuator arms, wherein there is one actuator arm per valve rod.

16. The method of claim 15, further comprising the act of coupling each of the multiple actuator arms to a single actuator base so that the multiple actuator arms operate synchronously.

17. The method of claim 16, further comprising the act of connecting more than one actuator mechanism with the actuator arm.

18. The method of claim 17, further comprising the act of selectively operating any number of the multiple actuator mechanisms to provide a desired force to the valve blade, wherein operating a greater number of actuator mechanisms will provide a greater force to the valve blade, and wherein operating a smaller number of actuator mechanisms will provide a lesser force to the valve blade.

19. A valve assembly for a processing chamber, comprising:
a valve blade reciprocally housed in a valve housing;
at least two valve rods, each of the valve rods reciprocally hosed in a vacuum tight housing, each of the rods having at least one magnet mounted thereupon and each of the valve rods imparting a reciprocal motion to the valve blade;
at least two actuator arms, each of the actuator arms having at least one complementary magnet mounted thereupon in a complementary position to the magnet mounted on a corresponding valve rod, wherein the magnet on the valve rod and the magnet on the actuator arm form a magnetic coupling through the housing; and,
a base coupling the at least two actuator arms so that the two actuator arms move in unison.

20. The valve assembly of claim 19, further comprising an actuator mechanism providing reciprocal motion to the base.
